(19) United States
(12) Patent Application Publication
(10) Pub. No.: US 2021/0099959 A1
(43) Pub. Date: Apr. 1, 2021

(54) DERIVING CONFIGURED OUTPUT POWERS WITH OVERLAPPING DURATIONS UNDER UPLINK PRE-EMPTION

(71) Applicant: Telefonaktiebolaget LM Ericsson (publ), Stockholm (SE)

(72) Inventors: Muhammad KAZMI, Sundbyberg (SE); Imadur RAHMAN, Sollentuna (SE); Ali BEHRAVAN, Stockholm (SE)

(21) Appl. No.: 16/970,051

(22) PCT Filed: Feb. 13, 2019
(86) PCT No.: PCT/EP2019/053550

§ 371 Date: Aug. 14, 2020

Related U.S. Application Data
(60) Provisional application No. 62/710,375, filed on Feb. 16, 2018.

(51) Int. Cl. H04W 52/14; H04W 52/36; H04W 52/44

(52) U.S. Cl. CPC H04W 52/146; H04W 52/44; H04W 52/367

(57) ABSTRACT

A method performed by network node is provided. A portion of a first scheduled transmission having a first transmission power is received during a first time period based at least in part on a first transmit power parameter. A second scheduled transmission having a second transmission power is received during a second time period that at least partially overlaps the first time period based at least in part on a second transmit power parameter different from the first transmit power parameter. A remaining portion of the first scheduled transmission having a third transmission power is received during a third time period occurring after the second time period based at least in part on a third transmit power parameter different from the second transmit power parameter, the third transmit power parameter being based at least in part on at least one operating condition of the second scheduled transmission.

### TECHNICAL FIELD

The present disclosure relates to wireless communications, and in particular, to output transmission power determination of overlapping durations under uplink preemption.

### BACKGROUND

New Radio (NR) The new radio (NR) standard (also known as “5G”) in 3GPP (3rd Generation Partnership Projection, a standardization organization) may be designed to provide service for multiple services such as enhanced mobile broadband (eMBB), ultra-reliable and low latency communication (URLLC), and machine type communication (MTC), etc. Each of these services has different technical requirements such as different transmission/reception requirements. For example, a general requirement for eMBB service is that may support high data rate with moderate latency and moderate coverage, while URLLC service may require a low latency and high reliability transmission but perhaps for moderate data rates.

One existing solution for low latency data transmission is to use shorter transmission time intervals. In NR, in addition to transmission in a slot, a mini-slot transmission is also allowed to help reduce latency. A mini-slot may consist of any number of 1 to 13 Orthogonal Frequency-Division Multiplexing (OFDM) symbols. The concepts of slot and mini-slot may not be specific to a specific service in that a mini-slot may be used for either eMBB, URLLC, or other services. A mini-slot may provide flexibility for scheduling in units that are smaller than a slot such as units of resource blocks or resource elements. FIG. 1 is a diagram of a radio resource in NR.

Latency Reduction with Mini-Slot Based Transmission

Packet data latency is one of the performance metrics that vendors, operators and also end-users (via speed test applications) regularly measure. Latency measurements may be performed in all phases of a radio access network system lifetime such as during verification of a new software release or system component, deployment of a system and/or during commercial operation of the system.

Trying to achieve shorter latency than previous generations of 3GPP radio access technologies (RATs) may have been one performance metric that guided the design of NR. NR helps provide faster access to internet and lower data latencies than previous generations of 3GPP RATs.

Packet data latency may be relevant not only for the perceived responsiveness of the system, but packet data latency is also a parameter that may indirectly influence the throughput of the system. Hypertext Transfer Protocol (HTTP)/Transmission Control Protocol (TCP) may be the dominating application and transport layer protocol suite used on the internet. The typical size of HTTP based transactions over the internet may be in the range of a few 10's of Kbyte up to 1 Mbyte. In this size range, the TCP slow start (congestion control strategy) period may be a significant part of the total transport period of the packet stream. During TCP slow start, the performance may be latency limited. Hence, improved latency can be showed to improve the average throughput, for this type of TCP based data transactions.

Radio resource efficiency could be positively impacted by latency reductions. Lower packet data latency could increase the number of possible transmissions within a certain delay limit. Lower Block Error Rate (BLER) targets could be used for the data transmissions, which may free up radio resources, thereby potentially improving the capacity of the system.

One area to address when it comes to the notion of packet latency reductions is the reduction of transport time of data and control signaling by addressing the length of a transmission time interval (TTI). In slot-based transmissions, scheduling may be performed based on slot durations such that transmission is planned for the duration of a slot, i.e., 14 symbols as an example minimum. However, in a mini-slot based scheduling, downlink (DL), i.e., from the network node to the wireless device, or uplink (UL), i.e., from the wireless device to the network node, transmission can be scheduled for a duration of shorter than a slot in order to address low latency transmission. This non-slot based transmission can have any duration in terms of number of OFDM or Single-Carrier Frequency Division Multiple Access (SC-FDMA) symbols. As one example, the duration of the mini-slot may be 2, 3, or 4, or 7 OFDM or SC-FDMA symbols.

UL Data Pre-Emption

Dynamic multiplexing of different services may be highly desirable for efficient use of system resources and to help maximize system capacity. In the downlink, the assignment of resources can be instantaneous and may be only limited by the scheduler (e.g., network node) implementation. Once low-latency data appears in a buffer of the network node, a network node can assign resources at an earliest time available to transmit the data. This may be either at the beginning of the subframe or at a mini-slot where the mini-slot can start at any OFDM symbol within the slot or the subframe. Similarly, in the UL it may be desirable that once the data arrives in the buffer some UL resources may be made available for transmission with as a low latency as possible.

The stringent latency budget of traffic such as URLLC traffic may require transmission of mini-slot signal(s) without waiting for vacant resources, thus the wireless device may need to stop an ongoing transmission to make some radio resources available for the transmission of data with low latency requirements on a mini-slot. Hence, there may be a need to handle intra wireless device 22 puncturing/preemption of slot data transmission. For example, wireless device 22 transmissions in a slot on already allocated resources may have to stop in order to allow wireless device 22 transmission in a mini-slot transmission.

As generally used herein, the terms “puncturing” and “pre-emption” have the same meaning so both terms are used interchangeably herein.

One example procedure of resource allocation with slot and mini-slot based transmission is illustrated in FIG. 2. A buffer (block 1) collects packets of slot data and reports data presence to Scheduler (block 7). Packets in the buffer (block 1) may be waiting for a scheduling command which triggers channel coding, Hybrid Automatic Repeat Request (HARQ) cyclic buffer forming and modulation procedures (block 3). Scheduler (block 7) may perform a decision about time-frequency ranges of modulated slot data and may provide this information to block S, which may be responsible for forming a time-frequency grid which consist of modulation symbols. Block 5 may be able to aggregate inputs from more than one source where an upper limit of the aggregation is defined by various factors known in the art.

In the process of forming the time-frequency grid, a mini-slot data can arrive in the buffer (block 2). Due to strict latency requirements for mini-slot data, the Scheduler (7) may determine to replace part of slot modulation symbols by mini-slot modulation symbols by triggering mini-slot channel coding, etc. Scheduler (7) may also send updated grid mapping information to block S.

The prepared time-frequency grid is transferred to block 6 for OFDM modulation and further signal processing such that a radio signal may be transmitted by block 8 to the antenna.

The Scheduler (7) could be (case 1) a logical part of a transmitting node (network node) or Scheduler (7) could be (case 2) located outside of transmitting node (wireless device). In the first case, signaling data between blocks may be delivered internally inside a network node. In the second case, external signaling links between scheduler and transmitting node are utilized.

HARQ retransmissions with incremental redundancy may use few redundancy versions (RV) that are different than those used for subsequent retransmissions.

Uplink Power Control

Uplink power control may have a role in radio resource management that has been implemented in modern communication systems. Uplink power control balances the need to maintain the link quality against the need to minimize interference to other wireless devices of the system and to maximize the battery life of the wireless device.

In Long Term Evolution (LTE), one aim of power control may be to determine the average power over a SC-FDMA symbol where it is applied for both common channel and dedicated channel (Physical Uplink Control Channel (PUCCH)/Physical Uplink Shared Channel (PUSCH)/Sounding Reference Signal (SRS)). A combined open-loop and closed-loop power control may be implement as illustrated in equation 1.

$${P}_{UE} = min \{ \begin{matrix}{P}_{CMAX} , \underbrace{{P}_{0} + α \cdot PL}_{open \text{-} loop set \text{-} point} + \underbrace{f ( i )}_{\begin{matrix}closed \text{-} loop \\ adjustment\end{matrix}} + \\ \underbrace{{Δ}_{TF} ( i )}_{MCS offset} + \underbrace{10 {log}_{10} M}_{bandwidth factor}\end{matrix} \} \qquad Equation 1$$

In Open loop power control: The wireless device calculates an open-loop set-point based on a path-loss estimate and network node controlled semi-static base level (P₀) including a nominal power level common for all wireless devices 22 in a cell and a wireless device 22 specific offset.

Closed-loop power control: Network node updates the dynamic adjustment relative to set-point, and wireless device 22 adjusts the transmit power based on Transmit Power Control (TPC) commands. The power control may also be connected to a modulation and coding scheme (MCS) used for the uplink transmission.

Uplink Power Control for Physical Uplink Shared Channel (PUSCH) and Physical Uplink Control Channel (PUCCH)

Uplink power control may be used both on the PUSCH and on PUCCH. One purpose of this uplink power control may be to help ensure that the wireless device transmits with sufficiently high but not too high power since the latter would increase the interference to other wireless devices in the network. In both cases, a parameterized open loop combined with a closed loop mechanism may be used. Roughly, the open loop part may be used to set a point of operation, around which the closed loop component operates. Different parameters (e.g., targets and partial compensation factors) for the wireless device and control plane are used.

In more detail, for PUSCH, the wireless device may set the output power according to

P_{PUSCHc} (i)=min{P_{MAXc},10log₁₀(M_{PUSCHc} (i))+P_{O_PUSCHc} (j)+α_{c}·PL_{c}+Δ_{TFc} (i)+f_{c} (i)}[dBm],

where P_{MAXc} is the maximum transmit power for the mobile terminal M_{PUSCHc} (i) is the number resource blocks assigned, P_{O_PUSCHc}(j) and α_{c} control the target received power, PL_{c} is the estimated pathloss, Δ_{TFc} (i) is transport format compensator and f_{c} (i) is the wireless device specific offset or ‘closed loop correction’ (the function f_{c} may represent either absolute or accumulative offsets). The index C numbers the component carrier and may only be of relevance for Carrier Aggregation.

The closed loop power control can be operated in two different modes either accumulated or absolute. Both modes are based on TPC, a command which is part of the downlink control signaling. When absolute power control is used, the closed loop correction function is reset every time a new power control command is received. When accumulated power control is used, the power control command is a delta correction with regard to the previously accumulated closed loop correction. The accumulated power control command may be defined as f_{c} (i)=f_{c} (i-1)+δ_{PUSCHc} (i-K_{PUSCH}), where δ_{PUSCHc} is the TPC command received in K_{PUSCH} subframe before the current subframe i and f_{c} (i-1) is the accumulated power control value. The absolute power control has no memory, i.e. f_{c} (i)=δ_{PUSCHc}(i-KPUSCH).

The PUCCH power control may have the same configurable parameters with the exception that PUCCH may only have full pathloss compensation, i.e., does only cover the case of α=1.

Configured Transmitted Power, PCMAX

Configured transmitted power PCMAX is defined in Section 6.2.5 of Technical Specification (TS) 3GPP 36.101 as written below:

6.2.5 Configured Transmitted Power

The UE is allowed to set its configured maximum output power P_{CMAX,c} for serving cell c. The configured maximum output power P_{CMAX,c} is set within the following bounds:

P_{CMAX_L,c}≤P_{CMAX,c}≤P_{CMAX_H,c} with

P_{CMAX_L,c}=MIN {P_{EMAx,c}-ΔT_{C,c}, P_{PowerClass}-MAX(MPR_{c}+A-MPR_{c}+ΔT_{IB,c}+ΔT_{C,c}, P-MPR_{c})}

P_{CMAX_H,c}=MIN {P_{EMAX,c}, P_{PowerClass}}

where
P_{EMAX,c} is the value given by IE P-Max for serving cell c;
P_{PowerClass} is the maximum UE power specified in Table 6.2.2-1 without taking into account the tolerance specified in the Table 6.2.2-1;
MPR_{c} and A-MPR_{c} for serving cell c are specified in subclause 6.2.3 and subclause 6.2.4, respectively;
ΔT_{IB,c} is the additional tolerance for serving cell c as specified in Table 6.2.5-2; ΔT_{IB,c}=0 dB otherwise;
ΔT_{C,c}=1.5 dB when Note 2 in Table 6.2.2-1 applies;
ΔT_{C,c}=0 dB when Note 2 in Table 6.2.2-1 does not apply.

P-MPR_{c} is the allowed maximum output power reduction for:

a) ensuring compliance with applicable electromagnetic energy absorption requirements and addressing unwanted emissions/self defense requirements in case of simultaneous transmissions on multiple RAT(s) for scenarios not in scope of 3GPP RAN specifications; and

b) ensuring compliance with applicable electromagnetic energy absorption requirements in case of proximity detection is used to address such requirements that require a lower maximum output power.

The wireless device (WD), e.g., user equipment (UE) should apply P-MPR_{c} for serving cell c only for the above cases. For WD conducted conformance testing, P-MPR shall be 0 dB.

NOTE 1: P-MPR_{c} was introduced in the P_{CMAX,c} equation such that the WD can report to the eNB the available maximum output transmit power. This information can be used by the eNB for scheduling decisions.

NOTE 2: P-MPR_{c} may impact the maximum uplink performance for the selected UL transmission path.

For each subframe, the P_{CMAX_L,c f}or serving cell c is evaluated per slot and given by the minimum value taken over the transmission(s) within the slot; the minimum P_{CMAX_L,c} over the two slots is then applied for the entire subframe. P_{PowerClass} shall not be exceeded by the WD during any period of time.

The measured configured maximum output power P_{UMAX,c} should be within the following bounds:

P_{CMAX_L,c}-MAX {T_{L}, T(P_{CMAX_L,c})}≤P_{UMAX,c}≤P_{CMAX_H,c}+T(P_{CMAX_H,c}) where T(P_{CMAX,c}) is defined by the tolerance table below and applies to P_{CMAX_L,c} and P_{CMAX_H,c} separately, while TL is the absolute value of the lower tolerance in Table 6.2.2-1 for the applicable operating band.

TABLE 6.2.5-1
P_{CMAX} tolerance

| | Tolerance |
|---|---|
| P_{CMAX,c} | T (P_{CMAX,c}) |
| (dBm) | (dB) |
| 23 < P_{CMAX,c} | 2.0 |
| ≤ 33 | |
| 21 ≤ P_{CMAX,c} | 2.0 |
| ≤ 23 | |
| 20 ≤ P_{CMAX,c} | 2.5 |
| < 21 | |
| 19 ≤ P_{CMAX,c} | 3.5 |
| < 20 | |
| 18 ≤ P_{CMAX,c} | 4.0 |
| < 19 | |
| 13 ≤ P_{CMAX,c} | 5.0 |
| < 18 | |
| 8 ≤ P_{CMAX,c} | 6.0 |
| < 13 | |
| −40 ≤ P_{CMAX,c} | 7.0 |
| < 8 | |

For the WD which supports inter-band carrier aggregation configurations with uplink assigned to one E-UTRA band the ΔT_{IB,c} may be defined for applicable bands

### SUMMARY

Some embodiments advantageously provide methods, systems, and apparatuses for output transmission power determination of overlapping durations under uplink preemption.

The disclosure includes several embodiments related to methods in the wireless device and the network node, which are described below.

According to the one or more embodiments, the wireless device estimates a first transmit power parameter (P1) for transmitting a first signals (S1) in a time resource (T1) and during T1 the wireless device may preempt the ongoing transmission of S2 for transmitting another signals, which is called herein as second signals (S2). The preemption due to S2 transmission may occur over a second time resource (T2), where T2 occurs within T1 (i.e., T2<T1). During at least the preemption duration (e.g., T2), the wireless device may puncture or discard S1 transmission. In case there is preemption of the signals S1 due to the transmission or expected transmission of S2, then the wireless device may further estimate a third transmission power parameter (P3) for transmitting the remaining part (S3) of the signals (S1) during a third time period (T3), where P3 is estimated based on at least the parameter P2, i.e., the power used for transmitting S2. The parameter P3 may be further estimated based on additional parameters related to transmission of the wireless device such as P1, T1, T3, etc. The wireless device may transmit the remaining signals, S3, during T3 while ensuring that the wireless device transmit power on signals S3 does not exceed the value P3.

In another embodiment, the wireless device may decide whether or not to estimate parameter, P3, and/or transmit signals, S3, during T3 due to preemption of S1 based on one or more rules. The rules can be pre-defined and/or configured by the network node. For example, the wireless device may estimate parameter, P3, and/or transmit signals, S3, during T3 provided that the preemption duration (T2) is smaller than certain duration threshold and/or the transmit power, P2 for S2 is smaller than certain power threshold.

Examples of signals S1 and S2 are eMBB and URLLC respectively. Examples of time resources T1 and T2 are slot and mini-slot respectively. Examples of mini-slot are 2 symbols, 3 symbols, 4 symbols, 7 symbols etc. Examples of transmit power parameters are wireless device maximum allowed transmission power, wireless device (WD) configured maximum out power (Pcmax), etc.

According to one aspect of the disclosure, a network node configured to communicate with a wireless device (WD) is provided. The network node is configured to, and/or comprising a radio interface and/or comprising processing circuitry configured to: configure a wireless device to transmit one or more first signals over a first time period, configure the wireless device to transmit one or more second signals over a second time period where the second time period is less than the first time period and the second time period at least partially overlaps the first time period, and receive at least a portion of the one or more first signals, transmitted using a first transmit power parameter, during the first time period. The radio interface and/or processing circuitry is further configured to: if the one or more second signals, transmitted using a second transmit power parameter, are received during the second time period, receive a remaining portion of the one or more first signals, transmitted using a third transmit power parameter, during a third time period where the third time period occurs after the second time period, and perform at least one operational task based on the received one or more first signals and one or more second signals.

According to another aspect of the disclosure, a wireless device (WD) configured to communicate with a network node is provided. The WD configured to, and/or comprising a radio interface and/or processing circuitry configured to: determine a first transmit power parameter for transmitting one or more first signals during a first time period, if one or more second signals are to be transmitted or are expected to be transmitted using a second transmit power parameter during a second time period, determine a third transmit power parameter for transmitting a portion of the one or more signals during a third time period, the second time period being less than the first time period where the second time period at least partially overlaps the first time period, the third time period occurring after the second time period; and transmit the one or more first signals and/or one or more second signals.

According to one aspect of the disclosure, a network node configured to communicate with a wireless device is provided. The network node includes processing circuitry and a radio interface. The processing circuitry is configured to receive, via the radio interface during a first time period, a portion of a first scheduled transmission having a first transmission power based at least in part on a first transmit power parameter. The processing circuitry is further configured to receive, via the radio interface during a second time period that at least partially overlaps the first time period, a second scheduled transmission having a second transmission power based at least in part on a second transmit power parameter different from the first transmit power parameter. The processing circuitry is further configured to receive, via the radio interface during a third time period occurring after the second time period, a remaining portion of the first scheduled transmission having a third transmission power based at least in part on a third transmit power parameter different from the second transmit power parameter. The third transmit power parameter is based at least in part on at least one operating condition of the second scheduled transmission.

According to one or more embodiments of this aspect, the second scheduled transmission preempts transmission of the first scheduled transmission during the second time period. According to one or more embodiments of this aspect, the at least one operating condition of the second scheduled transmission includes at least one of: a duration of the second time period, the second transmission power, and a location of the second scheduled transmission within a slot. According to one or more embodiments of this aspect, the third transmit power parameter is based at least in part on at least one of: a duration of the first time period, and the first transmission power.

According to one or more embodiments of this aspect, the third transmit power is based at least in part on a rule which includes whether the second transmit power parameter is below a predefined threshold. According to one or more embodiments of this aspect, the third transmit power is based at least in part on a rule which includes whether the second transmit power parameter is larger than the first transmit power parameter and within a predefined margin of the first transmit power parameter. According to one or more embodiments of this aspect, the third transmit power is based at least in part on a rule which includes whether a duration of the second time period is below a predefined duration threshold.

According to one or more embodiments of this aspect, the third transmit power is based at least in part on a rule which includes whether a duration of the second time period is less than a duration of the first time period and within a predefined margin of the duration of the first time period. According to one or more embodiments of this aspect, the third transmit power is based at least in part on a rule which includes whether the second scheduled transmission occurs within a predefined portion of a slot. According to one or more embodiments of this aspect, the first transmission power, second transmission power and third transmission power meet a predefined total output power criteria.

According to another aspect of the disclosure, a wireless device configured to communicate with a network node is provided. The wireless device includes processing circuitry and a radio interface. The processing circuitry is configured to cause the radio interface to transmit, during a first time period, a portion of a first scheduled transmission having a first transmission power based at least in part on a first transmit power parameter. The processing circuitry is further configured to cause the radio interface to transmit, during a second time period that at least partially overlaps the first time period, a second scheduled transmission having a second transmission power based at least in part on a second transmit power parameter different from the first transmit power parameter. The processing circuitry is further configured to cause the radio interface to transmit, during a third time period occurring after the second time period, a remaining portion of the first scheduled transmission having a third transmission power based at least in part on a third transmit power parameter different from the second transmit power parameter. The third transmit power parameter is based at least in part on at least one operating condition of the second scheduled transmission.

According to one or more embodiments of this aspect, the second scheduled transmission preempts transmission of the first scheduled transmission during the second time period. According to one or more embodiments of this aspect, the at least one operating condition of the second scheduled transmission includes at least one of a duration of the second time period, the second transmission power, and a location of the second scheduled transmission within a slot. According to one or more embodiments of this aspect, the third transmit power parameter is based at least in part on at least one of a duration of the first time period, and the first transmission power.

According to one or more embodiments of this aspect, the third transmit power is based at least in part on a rule which include whether the second transmit power parameter is below a predefined threshold. According to one or more embodiments of this aspect, the third transmit power is based at least in part on a rule which includes whether the second transmit power parameter is larger than the first transmit power parameter and within a predefined margin of the first transmit power parameter. According to one or more embodiments of this aspect, the third transmit power is based at least in part on a rule which includes whether a duration of the second time period is below a predefined duration threshold. According to one or more embodiments of this aspect, the third transmit power is based at least in part on a rule which includes whether a duration of the second time period is less than a duration of the first time period and within a predefined margin of the duration of the first time period. According to one or more embodiments of this aspect, the third transmit power is based at least in part on a rule which includes whether the second scheduled transmission occurs within a predefined portion of a slot. According to one or more embodiments of this aspect, the first transmission power, second transmission power and third transmission power meet a predefined total output power criteria.

According to another aspect of the disclosure, a method performed by network node configured to communicate with a wireless device is provided. A portion of a first scheduled transmission having a first transmission power is received during a first time period based at least in part on a first transmit power parameter. A second scheduled transmission having a second transmission power is received during a second time period that at least partially overlaps the first time period based at least in part on a second transmit power parameter different from the first transmit power parameter. A remaining portion of the first scheduled transmission having a third transmission power is received during a third time period occurring after the second time period based at least in part on a third transmit power parameter different from the second transmit power parameter, the third transmit power parameter being based at least in part on at least one operating condition of the second scheduled transmission.

According to one or more embodiments of this aspect, the second scheduled transmission preempts transmission of the first scheduled transmission during the second time period. According to one or more embodiments of this aspect, the at least one operating condition of the second scheduled transmission includes at least one of a duration of the second time period, the second transmission power, and a location of the second scheduled transmission within a slot. According to one or more embodiments of this aspect, the third transmit power parameter is based at least in part on at least one of a duration of the first time period and the first transmission power.

According to one or more embodiments of this aspect, the third transmit power parameter is based at least in part on whether at least one rule is met. According to one or more embodiments of this aspect, the at least one rule includes whether the second transmit power parameter is below a predefined threshold. According to one or more embodiments of this aspect, the third transmit power is based at least in part on a rule which includes whether the second transmit power parameter is larger than the first transmit power parameter and within a predefined margin of the first transmit power parameter. According to one or more embodiments of this aspect, the third transmit power is based at least in part on a rule which includes whether a duration of the second time period is below a predefined duration threshold.

According to one or more embodiments of this aspect, the third transmit power is based at least in part on a rule which includes whether a duration of the second time period is less than a duration of the first time period and within a predefined margin of the duration of the first time period. According to one or more embodiments of this aspect, the third transmit power is based at least in part on a rule which includes whether the second scheduled transmission occurs within a predefined portion of a slot. According to one or more embodiments of this aspect, the first transmission power, second transmission power and third transmission power meet a predefined total output power criteria.

According to another aspect of the disclosure, a method for a wireless device configured to communicate with a network node is provided. A portion of a first scheduled transmission having a first transmission power is transmitted during a first time period based at least in part on a first transmit power parameter. A second scheduled transmission having a second transmission power is transmitted during a second timer period that at least partially overlaps the first time period based at least in part on a second transmit power parameter different from the first transmit power parameter. A remaining portion of the first scheduled transmission having a third transmission power is transmitted during a third time period occurring after the second time period based at least in part on a third transmit power parameter different from the second transmit power parameter, the third transmit power parameter being based at least in part on at least one operating condition of the second scheduled transmission.

According to one or more embodiments of this aspect, the second scheduled transmission preempts transmission of the first scheduled transmission during the second time period. According to one or more embodiments of this aspect, the at least one operating condition of the second scheduled transmission includes at least one of a duration of the second time period, the second transmission power, and a location of the second scheduled transmission within a slot. According to one or more embodiments of this aspect, the third transmit power parameter is based at least in part on at least one of a duration of the first time period, and the first transmission power.

According to one or more embodiments of this aspect, the third transmit power is based at least in part on a rule which include whether the second transmit power parameter is below a predefined threshold. According to one or more embodiments of this aspect, the third transmit power is based at least in part on a rule which includes whether the second transmit power parameter is larger than the first transmit power parameter and within a predefined margin of the first transmit power parameter.

According to one or more embodiments of this aspect, the third transmit power is based at least in part on a rule which includes whether a duration of the second time period is below a predefined duration threshold. According to one or more embodiments of this aspect, the third transmit power is based at least in part on a rule which includes whether a duration of the second time period is less than a duration of the first time period and within a predefined margin of the duration of the first time period. According to one or more embodiments of this aspect, the third transmit power is based at least in part on a rule which includes whether the second scheduled transmission occurs within a predefined portion of a slot. According to one or more embodiments of this aspect, the first transmission power, second transmission power and third transmission power meet a predefined total output power criteria.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of radio resources in new radio;

FIG. 2 is a diagram of an example implementation of resource allocation and transmission;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a block diagram of an alternative embodiment of a host computer according to some embodiments of the present disclosure;

FIG. 6 is a block diagram of an alternative embodiment of a network node according to some embodiments of the present disclosure;

FIG. 7 is a block diagram of an alternative embodiment of a wireless device according to some embodiments of the present disclosure;

FIG. 8 is a flowchart illustrating exemplary methods implemented in a communication system including a host computer, a network node and a wireless device for executing a client application at a wireless device according to some embodiments of the present disclosure;

FIG. 9 is a flowchart illustrating exemplary methods implemented in a communication system including a host computer, a network node and a wireless device for receiving user data at a wireless device according to some embodiments of the present disclosure;

FIG. 10 is a flowchart illustrating exemplary methods implemented in a communication system including a host computer, a network node and a wireless device for receiving user data from the wireless device at a host computer according to some embodiments of the present disclosure;

FIG. 11 is a flowchart illustrating exemplary methods implemented in a communication system including a host computer, a network node and a wireless device for receiving user data at a host computer according to some embodiments of the present disclosure;

FIG. 12 is a flowchart of an exemplary process in a network node for configuring a wireless device over one or more time periods according to some embodiments of the present disclosure;

FIG. 13 is a flowchart of another exemplary process in a network node for configuring a wireless device over one or more time periods according to some embodiments of the present disclosure;

FIG. 14 is a flowchart of an exemplary process in a wireless device for determining transmission parameters for transmission of signals according to some embodiments of the present disclosure;

FIG. 15 is a flowchart of an exemplary process in a wireless device for determining transmission parameters for transmission of signals according to some embodiments of the present disclosure;

FIG. 16 is a diagram of a case where a maximum output power of the wireless device is re-estimated for transmission in a third time period due to the occurrence of preemption in a second time period; and

FIG. 17 is a flowchart of an exemplary process in a wireless device for re-estimation of transmit power for transmitting a first signal that is preempted by a second signal during at least a portion of a time period according to some embodiments of the present disclosure.

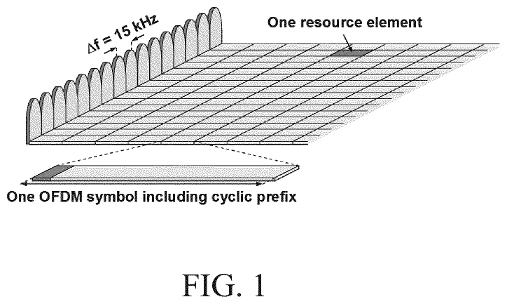

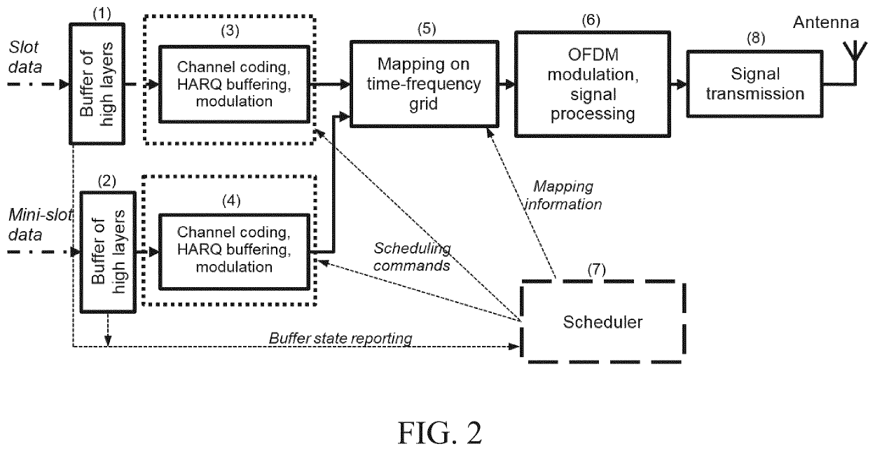

### DETAILED DESCRIPTION

In some systems, the minimum wireless device transmit max power PCMAX_L,c may be evaluated per slot by the wireless device in every subframe as the minimum resource unit is 1 RB, which corresponds to one slot. With the introduction of mini-slots (which may be 2, 3, 4 or 7 symbols, for example), the wireless device can be scheduled for communication using smaller time intervals than a slot. However, there is no rule or method for estimating Pcmax if the wireless device is configured with a mini-slot when a slot-level transmission is already being planned or configured.

The disclosure addresses the problem described above at least in part by providing output transmission power determinations of overlapping durations under uplink preemption and/or methods to derive configured output powers with overlapping durations under UL preemption, as described herein.

The following one or more advantages may be obtained using the teaching of the disclosure:
The wireless device behavior with respect to configured transmitted power may be well defined for different transmission durations.
The wireless device behavior with respect to configured transmitted power may be well defined when different transmission patterns are used.
The operation related to the transmission of signals by the wireless device configured with the same or different transmission durations, may be enhanced or improved with respect to one or more transmission/reception metrics/parameters.

Before describing in detail exemplary embodiments, it is noted that the embodiments reside primarily in combinations of apparatus components and processing steps related to output transmission power determination of overlapping durations under uplink preemption. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, integrated access and backhaul (IAB), access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Other Generalizations

In this disclosure, a first node and a second node are sometimes used as two nodes which are either transmitting or receiving in a licensed or in an unlicensed spectrum (or a shared spectrum where more than one system operates based on some kind of sharing regulations). An example of a first node could be a network node, which could be a more general term and can correspond to any type of radio network node or any network node, which communicates with a wireless device and/or with another network node. Examples of network nodes are NodeB, base station (BS), multi-standard radio (MSR) radio node such as MSR BS, eNodeB, gNodeB. MeNB, SeNB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), IAB nodes in distributed antenna system (DAS), core network node (e.g. Mobile Switching Center (MSC), Mobility Management Entity (MME), etc.), O&M, OSS, SON, positioning node (e.g. E-SMLC), MDT etc.

Another example of a node could be wireless device, this is a non-limiting term wireless device and it refers to any type of wireless device communicating with a network node and/or with another wireless device in a cellular or mobile communication system. Examples of wireless devices are target device, user equipment (UE), device to device (D2D) wireless device, machine type wireless device or wireless device capable of machine to machine (M2M) communication, PDA, iPAD, Tablet, mobile terminals, smart phone, laptop embedded equipped (LEE), laptop mounted equipment (LME), USB dongles etc.

In some embodiments generic terminology, “radio network node” or simply “network node (NW node)”, is used. It can be any kind of network node which may comprise of base station, radio base station, base transceiver station, base station controller, network controller, evolved Node B (eNB), Node B, gNB, relay node, access point, radio access point, Remote Radio Unit (RRU) Remote Radio Head (RRH) etc.

In this disclosure, any of the above mentioned nodes could become “the first node” and/or “the second node”. The term radio access technology, or RAT, may refer to any RAT, e.g., UTRA, E-UTRA, narrow band internet of things (NB-IoT), WiFi, Bluetooth, next generation RAT (NR), 4G, 5G, etc. Any of the first and the second nodes may be capable of supporting a single or multiple RATs.

A wireless device may be configured to operate in carrier aggregation (CA) and/or dual connectivity (DC) implying aggregation of two or more carriers in at least one of DL and UL directions. With CA and/or DC, a wireless device can have multiple serving cells, where the term ‘serving’ herein may signify that the wireless device is configured with the corresponding serving cell and may receive from and/or transmit data to the network node on the serving cell, e.g., on PCell or any of the SCells. The data is transmitted or received via physical channels, e.g., PDSCH in DL, PUSCH in UL etc. A component carrier (CC) also interchangeably called as carrier or aggregated carrier, primary CC (PCC) or secondary CC (SCC) is configured at the wireless device by the network node using higher layer signaling e.g. by sending RRC configuration message to the wireless device. The configured CC is used by the network node for serving the wireless device on the serving cell (e.g., on PCell, PSCell, SCell, etc.) of the configured CC. The configured CC is also used by the wireless device for performing one or more radio measurements (e.g., Reference Signal Received Power (RSRP), Reference Signal Received Quality (RSRQ), etc.) on the cells operating on the CC e.g. PCell, SCell or PSCell and neighboring cells.

The term signal used herein can be any physical signal or physical channel. Examples of physical signals are reference signal such as primary synchronization signal (PSS), secondary synchronization signal (SSS), Cell Specific Reference Signal (CRS), Positioning Reference Signals (PRS), sounding reference signal (SRS), Demodulation Reference Signal (DMRS), Channel State Information Reference Signal (CSI-RS), etc. The term physical channel (e.g., in the context of channel reception) used herein is also called as ‘channel. Examples of physical channels are Master Information Block (MIB), Physical Broadcast Channel (PBCH), narrowband PBCH (NPBCH), Physical Downlink Control Channel (PDCCH), Physical Downlink Shared Channel (PDSCH), short PUCCH (sPUCCH), short PDSCH (sPDSCH), short Physical Uplink Control Channel (sPUCCH), short Physical Uplink Shared Channel (sPUSCH), narrowband PDCCH (NPDCCH), narrowband PDCCH (NPDCCH), narrowband PDSCH (NPDSCH), E-PDCCH, PUSCH, PUCCH, narrow band PUSCH (NPUSCH) etc.

The term time resource used herein may correspond to any type of physical resource or radio resource expressed in terms of length of time. Examples of time resources are: symbol, mini-slot, time slot, subframe, radio frame, TTI, interleaving time, etc.

The term TTI used herein may correspond to any time period over which a physical channel can be encoded and interleaved for transmission. The physical channel is decoded by the receiver over the same time period (T0) over which it was encoded. The TTI may also interchangeably called as short TTI (sTTI), transmission time, slot, sub-slot, mini-slot, short subframe (SSF), mini-subframe, etc.

The term transmit power or transmit power level or configured output power used herein can be any one or more parameters associated with the transmit power of the wireless device. Examples of such parameters are the wireless device maximum output power, wireless device average transmit power, PCMAX of the wireless device, etc. The wireless device power can be estimated or measured at the antenna connector of the wireless device (e.g., conducted output power) or it can be estimated or measured over the air (e.g. over the air (OTA) output power). The OTA maximum output power can therefore be expressed in terms of total radiated power (TRP) and Effective Isotropic Radiated Power (EIRP). Therefore, the parameter can be expressed in terms of conducted transmit power, total radiated power (TRP), EIRP, etc.

The term Pcmax used herein may correspond to any parameter defining wireless device maximum output power. The parameter may be pre-defined or configured. In some embodiments, transmit power is called as Pcmax. The parameter may be equal to or less than the nominal output power of the wireless device. Pcmax is also interchangeably called herein as wireless device maximum transmit power, wireless device maximum configured power, wireless device maximum operating power, etc.

The term pre-emption used herein refers to a procedure or an operation for stopping an ongoing transmission of a first set of signals (S1) in order to allow transmission of another, second, set of signals (S2). The second set of signals (S2) are transmitted or intended to be transmitted during the time period when there is an ongoing transmission of the first set of signals (S1). The other non-limiting terms corresponding to or that can be used for describing pre-emption are puncturing of transmissions of signals, dropping of transmission of signals, deferring transmissions of signals, stopping of transmission of signals, etc. The pre-emption can be performed by the wireless device on uplink signals or by the network node on downlink signals.

Details relating to various embodiments are described below. Embodiments provide output transmission power determination of overlapping durations under uplink preemption and/or methods to derive configured output powers with overlapping durations under UL preemption.

Generally, configuring may include determining configuration data representing the configuration and providing, e.g. transmitting, it to one or more other nodes (parallel and/or sequentially), which may transmit it further to the radio node (or another node, which may be repeated until it reaches the wireless device 22). Alternatively, or additionally, configuring a radio node, e.g., by a network node 16 or other device, may include receiving configuration data and/or data pertaining to configuration data, e.g., from another node like a network node 16, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD 22) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD 22) may comprise configuring the WD 22 for transmission.

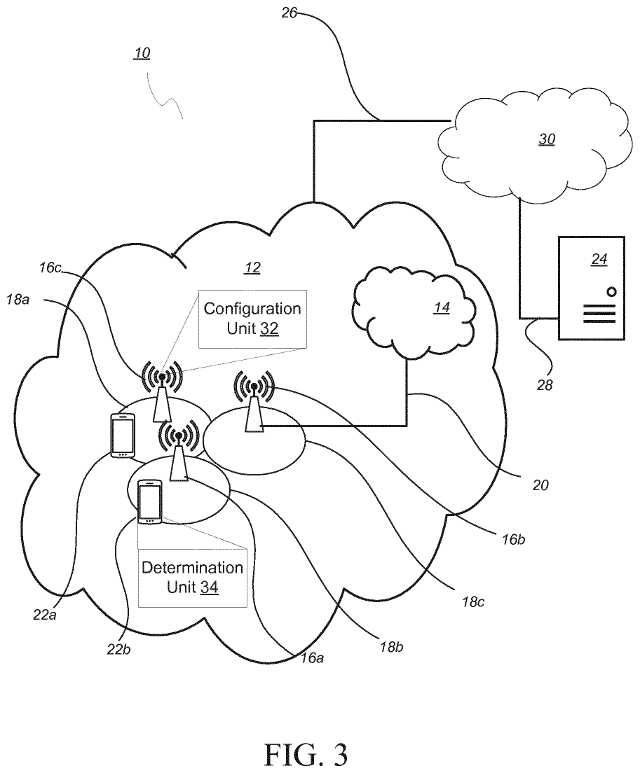

Returning again to the drawing figures, in which like elements are referred to by like reference numerals, there is shown in FIG. 3 a schematic diagram of a communication system, according to an embodiment, including a communication system 10, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a , 18b , 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB—for LTE/E-UTRAN and a gNB for NR/NextGen RAN (NG-RAN).

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure a wireless device to transmit one or more first signals over a first time period, and configure the wireless device to transmit one or more second signals over a second time period where the second time period is less than the first time period and the second time period at least partially overlaps the first time period, as described herein. A wireless device 22 is configured to include a determination unit 34 which is configured to determine a first transmit power parameter for transmitting one or more first signals during a first time period, and, if one or more second signals are to be transmitted or are expected to be transmitted using a second transmit power parameter during a second time period, determine a third transmit power parameter for transmitting a portion of the one or more signals during a third time period, the second time period being less than the first time period where the second time period at least partially overlaps the first time period, the third time period occurring after the second time period, as described herein.

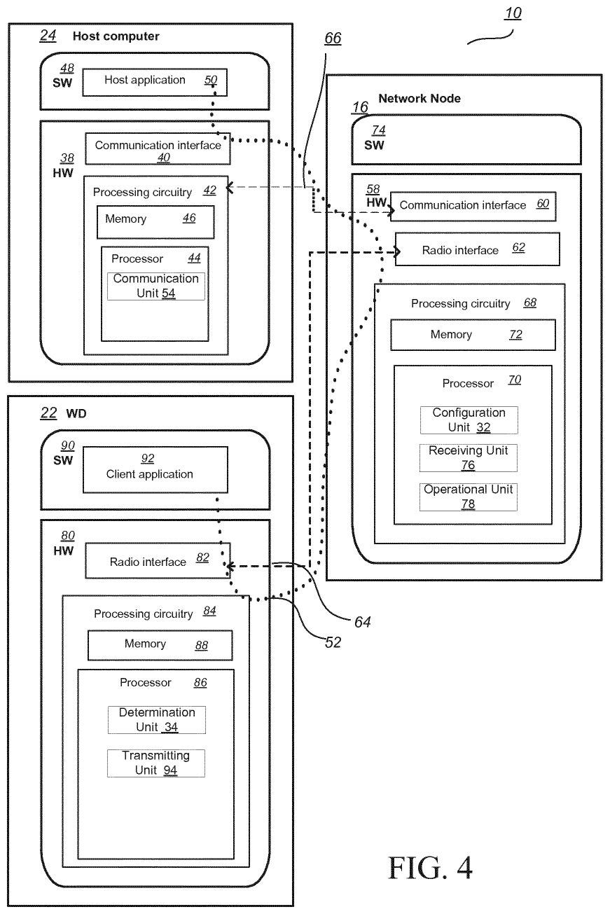

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a communication unit 54 configured to enable the service provider to communicate information associated with a transmission of one or more first signals and one or more second signals, where the one or more second signals preempt the transmission of a portion of the one or more first signals during a time period.

The communication system 10 further includes a network node 16 provided in a communication system 10 and comprising hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to configure a wireless device to transmit one or more first signals over a first time period, and configure the wireless device to transmit one or more second signals over a second time period where the second time period is less than the first time period and the second time period at least partially overlaps the first time period. The processing circuitry 68 may also include receiving unit 76 configured to receive at least a portion of the one or more first signals, transmitted using a first transmit power parameter, during the first time period; and if the one or more second signals, transmitted using a second transmit power parameter, are received during the second time period, receive a remaining portion of the one or more first signals, transmitted using a third transmit power parameter, during a third time period where the third time period occurs after the second time period. The processing circuitry 68 may also include operational unit 78 configured to perform at least one operational task based on the received one or more first signals and one or more second signals.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a determination unit 34 configured to determine a first transmit power parameter for transmitting one or more first signals during a first time period, and if one or more second signals are to be transmitted or are expected to be transmitted using a second transmit power parameter during a second time period, determine a third transmit power parameter for transmitting a portion of the one or more signals during a third time period. The second time period is less than the first time period where the second time period at least partially overlaps the first time period, and the third time period occurs after the second time period. The processing circuitry 84 may also include transmitting unit 94 configured to transmit the one or more first signals and/or one or more second signals.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as configuration unit 32, determination unit 34, receiving unit 76, operational unit 78 and transmitting unit 94 as being within a respective processor, it is contemplated that these units may be implemented such that a portion of the unit is stored in a corresponding memory within the processing circuitry. In other words, the units may be implemented in hardware or in a combination of hardware and software within the processing circuitry.

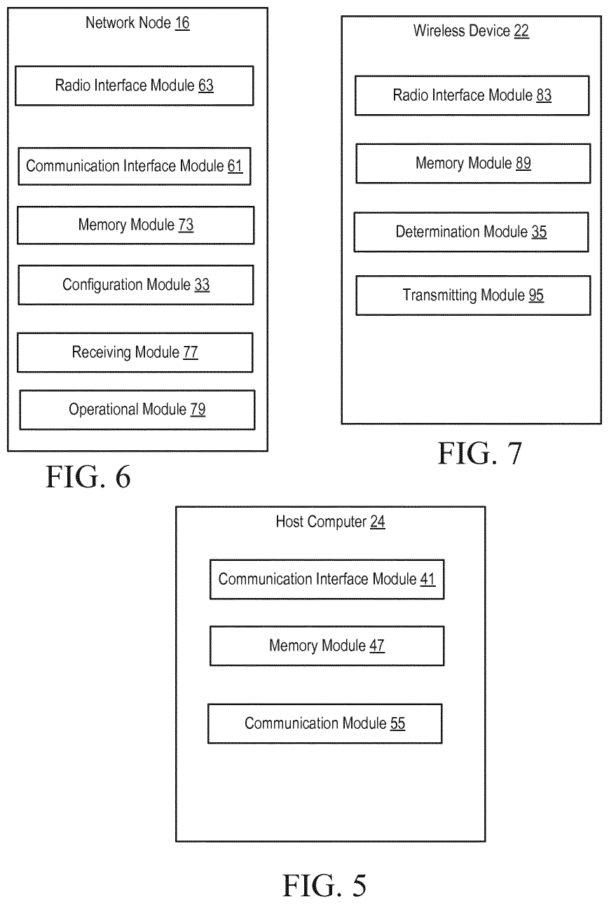

FIG. 5 is a block diagram of an alternative host computer 24, which may be implemented at least in part by software modules containing software executable by a processor to perform the functions described herein. The host computer 24 includes a communication interface module 41 configured to set up and maintain a wired or wireless connection with an interface of a different communication device of the communication system 10. The memory module 47 is configured to store data, programmatic software code and/or other information described herein. Communication module 55 is configured to enable the service provider to communicate information associated with a transmission of one or more first signals and one or more second signals, the one or more second signals preempting the transmission of a portion of the one or more first signals during a time period.

FIG. 6 is a block diagram of an alternative network node 16, which may be implemented at least in part by software modules containing software executable by a processor to perform the functions described herein. The network node 16 includes a radio interface module 63 configured for setting up and maintaining at least a wireless connection 64 with a WD 22 located in a coverage area 18 served by the network node 16. The network node 16 also includes a communication interface module 61 configured for setting up and maintaining a wired or wireless connection with an interface of a different communication device of the communication system 10. The communication interface module 61 may also be configured to facilitate a connection 66 to the host computer 24. The memory module 73 that is configured to store data, programmatic software code and/or other information described herein. The configuration module 33 is configured to configure a wireless device to transmit one or more first signals over a first time period, and configure the wireless device to transmit one or more second signals over a second time period where the second time period is less than the first time period and the second time period at least partially overlaps the first time period. The receiving module 77 is configured to receive at least a portion of the one or more first signals, transmitted using a first transmit power parameter, during the first time period, and if the one or more second signals, transmitted using a second transmit power parameter, are received during the second time period, receive a remaining portion of the one or more first signals, transmitted using a third transmit power parameter, during a third time period where the third time period occurs after the second time period. The operational module 79 is configured to perform at least one operational task based on the received one or more first signals and one or more second signals.

FIG. 7 is a block diagram of an alternative wireless device 22, which may be implemented at least in part by software modules containing software executable by a processor to perform the functions described herein. The WD 22 includes a radio interface module 83 configured to set up and maintain a wireless connection 64 with a network node 16 serving a coverage area 18 in which the WD 22 is currently located. The memory module 89 is configured to store data, programmatic software code and/or other information described herein. The determination module 35 is configured to determine a first transmit power parameter for transmitting one or more first signals during a first time period, and if one or more second signals are to be transmitted or are expected to be transmitted using a second transmit power parameter during a second time period, determine a third transmit power parameter for transmitting a portion of the one or more signals during a third time period. The second time period is less than the first time period where the second time period at least partially overlaps the first time period, and the third time period occurs after the second time period. The transmitting module 95 is configured to transmit the one or more first signals and/or one or more second signals.

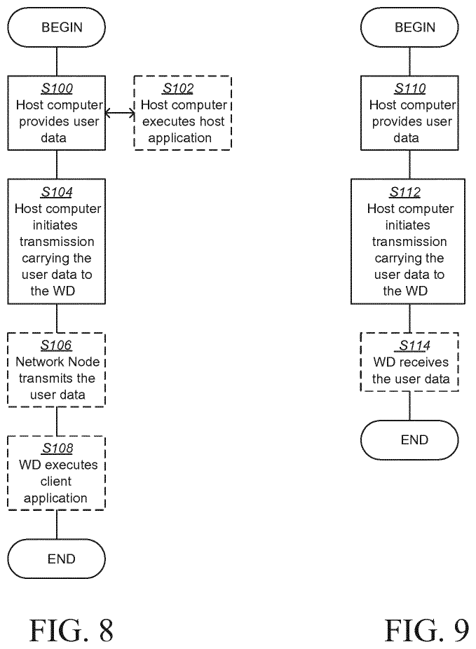

FIG. 8 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (block S100). In an optional substep of the first step, the host computer 24 provides the user data by executing a host application, such as, for example, the host application 50 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 92, associated with the host application 50 executed by the host computer 24 (block S108).

FIG. 9 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (block S110). In an optional substep (not shown) the host computer 24 provides the user data by executing a host application, such as, for example, the host application 50. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

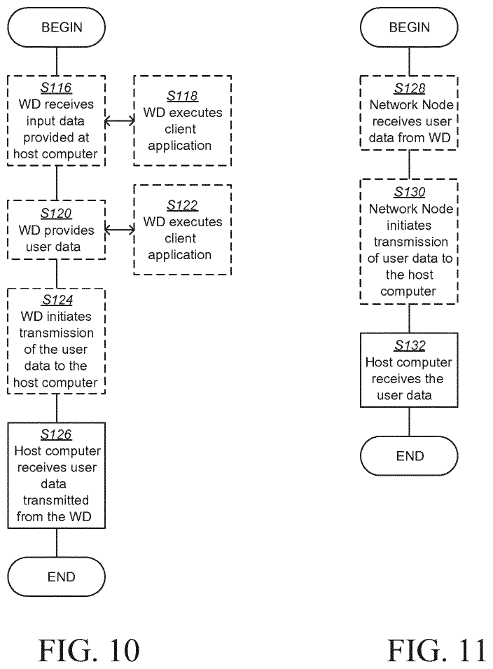

FIG. 10 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 92 (block S122). In providing the user data, the executed client application 92 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 11 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

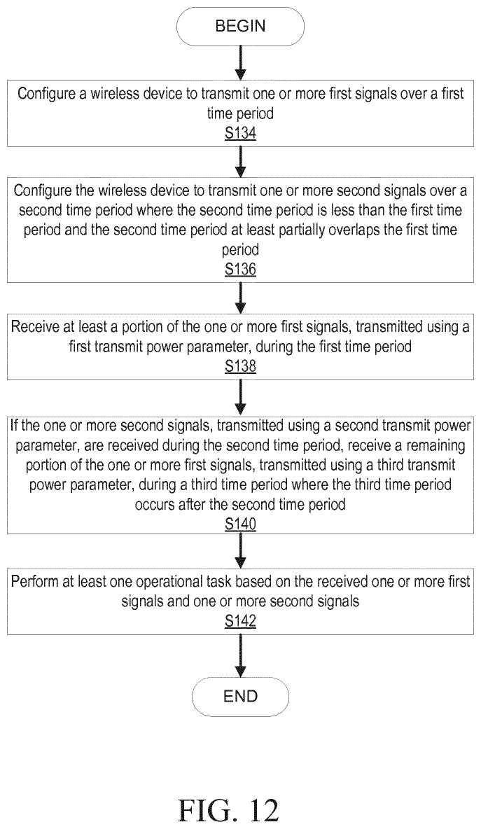

FIG. 12 is a flowchart of an exemplary process in a network node 16 according to some embodiments of the present disclosure. Processing circuitry 68 is configured to configure a wireless device to transmit one or more first signals over a first time period, as described herein (block S134). Processing circuitry 68 is configured to configure the wireless device to transmit one or more second signals over a second time period where the second time period is less than the first time period and the second time period at least partially overlaps the first time period, as described herein (block S136). Processing circuitry 68 is configured to receive at least a portion of the one or more first signals, transmitted using a first transmit power parameter, during the first time period, as described herein (block S138). Processing circuitry 68 is configured to, if the one or more second signals, transmitted using a second transmit power parameter, are received during the second time period, receive a remaining portion of the one or more first signals, transmitted using a third transmit power parameter, during a third time period where the third time period occurs after the second time period, as described herein (block S140). Processing circuitry 68 is configured to perform at least one operational task based on the received one or more first signals and one or more second signals, as described herein (block S142).

In one or more embodiments, transmission of the one or more first signals during a portion of the first time period are preempted by the transmission of the one or more second signals during the second time period. In one or more embodiments, the third transmit power parameter is based on the first transmit power parameter, second transmit power parameter, first time period and second time period.

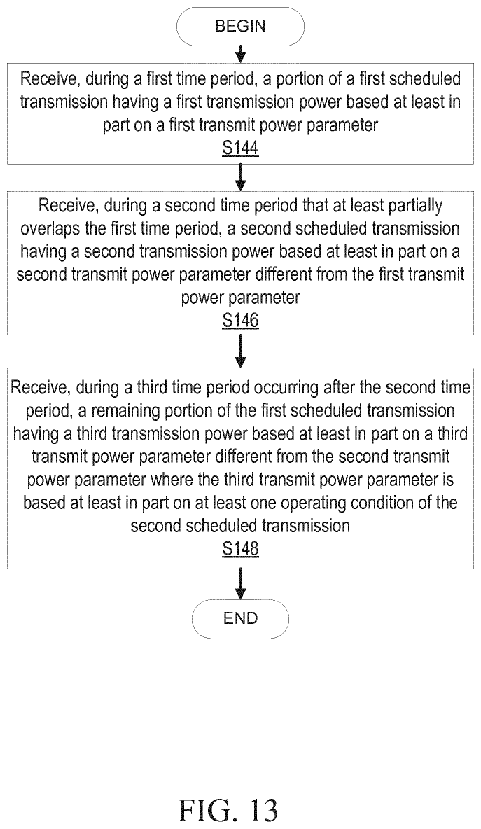

FIG. 13 is a flowchart of another exemplary process in a network node 16 according to some embodiments of the present disclosure. One or more Blocks and/or functions performed by network node 16 may be performed by one or more elements of network node 16 such as by configuration unit 32 in processing circuitry 68, processor 70, radio interface 62, etc. In one or more embodiments, network node 16 such as via one or more of processing circuitry 68, processor 70 and radio interface 62 is configured to receive (block S144), via the radio interface 62 during a first time period, a portion of a first scheduled transmission having a first transmission power based at least in part on a first transmit power parameter, as described herein. In one or more embodiments, network node 16 such as via one or more of processing circuitry 68, processor 70 and radio interface 62 is configured to receive (block S146), via the radio interface 62 during a second time period that at least partially overlaps the first time period, a second scheduled transmission having a second transmission power based at least in part on a second transmit power parameter different from the first transmit power parameter, as described herein. In one or more embodiments, network node 16 such as via one or more of processing circuitry 68, processor 70 and radio interface 62 is configured to receive (block S148), via the radio interface 62 during a third time period occurring after the second time period, a remaining portion of the first scheduled transmission having a third transmission power based at least in part on a third transmit power parameter different from the second transmit power parameter where the third transmit power parameter is based at least in part on at least one operating condition of the second scheduled transmission, as described herein.

According to one or more embodiments, the second scheduled transmission preempts transmission of the first scheduled transmission during the second time period. According to one or more embodiments, the at least one operating condition of the second scheduled transmission includes at least one of: a duration of the second time period, the second transmission power, and a location of the second scheduled transmission within a slot.

According to one or more embodiments, the third transmit power parameter is based at least in part on at least one of: a duration of the first time period, and the first transmission power. According to one or more embodiments, the third transmit power is based at least in part on a rule which includes whether the second transmit power parameter is below a predefined threshold.

According to one or more embodiments, the third transmit power is based at least in part on a rule which includes whether the second transmit power parameter is larger than the first transmit power parameter and within a predefined margin of the first transmit power parameter. According to one or more embodiments, the third transmit power is based at least in part on a rule which includes whether a duration of the second time period is below a predefined duration threshold. According to one or more embodiments, the third transmit power is based at least in part on a rule which includes whether a duration of the second time period is less than a duration of the first time period and within a predefined margin of the duration of the first time period.

According to one or more embodiments, the third transmit power is based at least in part on a rule which includes whether the second scheduled transmission occurs within a predefined portion of a slot. According to one or more embodiments, the first transmission power, second transmission power and third transmission power meet a predefined total output power criteria.

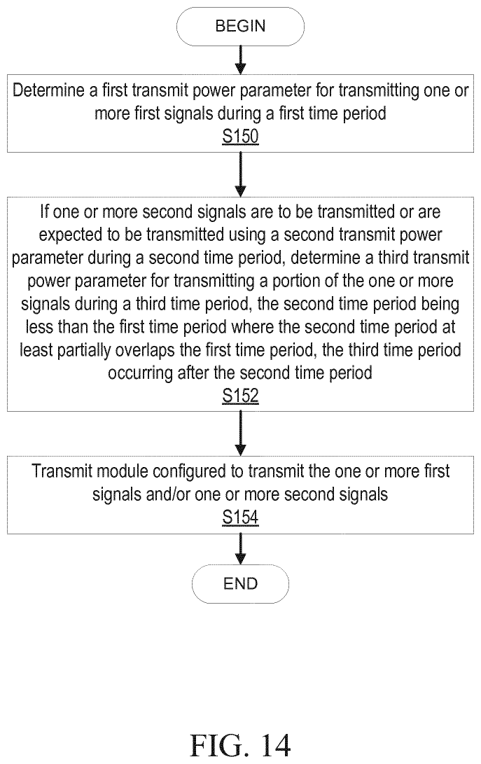

FIG. 14 is a flowchart of an exemplary process in a wireless device 22 according to some embodiments of the present disclosure. Processing circuitry 84 is configured to determine a first transmit power parameter for transmitting one or more first signals during a first time period, as described herein (block S150). Processing circuitry 84 is configured to if one or more second signals are to be transmitted or are expected to be transmitted using a second transmit power parameter during a second time period, determine a third transmit power parameter for transmitting a portion of the one or more signals during a third time period, where the second time period is less than the first time period where the second time period at least partially overlaps the first time period, and where the third time period occurs after the second time period as described herein (block S152). Processing circuitry 84 is configured to transmit the one or more first signals and/or one or more second signals, as described herein (block S154).

In one or more embodiments, transmission of the one or more first signals during a portion of the first time period are preempted by the transmission of the one or more second signals during the second time period. In one or more embodiments, the third transmit power parameter is based on the first transmit power parameter, second transmit power parameter, first time period and second time period.

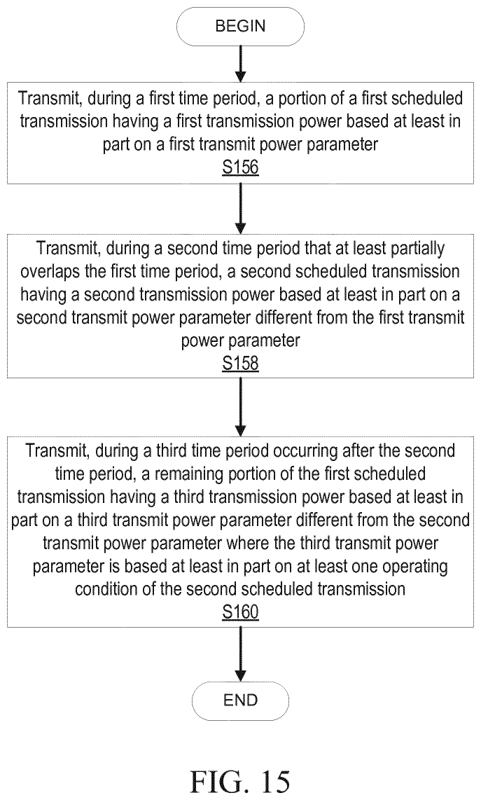

FIG. 15 is a flowchart of another exemplary process in a wireless device 22 according to some embodiments of the present disclosure. One or more Blocks and/or functions performed by wireless device 22 may be performed by one or more elements of wireless device 22 such as by determination unit 34 in processing circuitry 84, processor 86, radio interface 82, etc. In one or more embodiments, wireless device 22 such as via one or more of processing circuitry 84, processor 86 and radio interface 82 is configured to cause (block S156) the radio interface to transmit, during a first time period, a portion of a first scheduled transmission having a first transmission power based at least in part on a first transmit power parameter. In one or more embodiments, wireless device 22 such as via one or more of processing circuitry 84, processor 86 and radio interface 82 is configured to cause (block S158) the radio interface to transmit, during a second time period that at least partially overlaps the first time period, a second scheduled transmission having a second transmission power based at least in part on a second transmit power parameter different from the first transmit power parameter, as described herein. In one or more embodiments, wireless device 22 such as via one or more of processing circuitry 84, processor 86 and radio interface 82 is configured to (block S160) cause the radio interface to transmit, during a third time period occurring after the second time period, a remaining portion of the first scheduled transmission having a third transmission power based at least in part on a third transmit power parameter different from the second transmit power parameter where the third transmit power parameter is based at least in part on at least one operating condition of the second scheduled transmission, as described herein.

According to one or more embodiments, the second scheduled transmission preempts transmission of the first scheduled transmission during the second time period. According to one or more embodiments, the at least one operating condition of the second scheduled transmission includes at least one of a duration of the second time period, the second transmission power, and a location of the second scheduled transmission within a slot. According to one or more embodiments, the third transmit power parameter is based at least in part on at least one of a duration of the first time period, and the first transmission power.

According to one or more embodiments, the third transmit power is based at least in part on a rule which include whether the second transmit power parameter is below a predefined threshold. According to one or more embodiments, the third transmit power is based at least in part on a rule which includes whether the second transmit power parameter is larger than the first transmit power parameter and within a predefined margin of the first transmit power parameter.

According to one or more embodiments, the third transmit power is based at least in part on a rule which includes whether a duration of the second time period is below a predefined duration threshold. According to one or more embodiments, the third transmit power is based at least in part on a rule which includes whether a duration of the second time period is less than a duration of the first time period and within a predefined margin of the duration of the first time period. According to one or more embodiments, the third transmit power is based at least in part on a rule which includes whether the second scheduled transmission occurs within a predefined portion of a slot. According to one or more embodiments, the first transmission power, second transmission power and third transmission power meet a predefined total output power criteria.

Details relating to various embodiments are described below. Embodiments provide output transmission power determination of overlapping durations under uplink preemption and/or methods to derive configured output powers with overlapping durations under UL preemption. Methods in a wireless device of determining and using configured maximum output power under preemption for uplink transmission

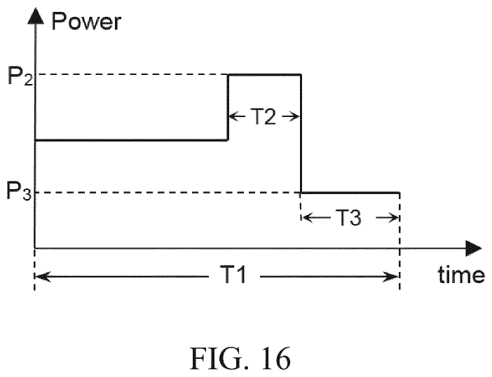

This scenario comprises a WD 22 configured or scheduled to transmit first uplink signals (S1) with a first time period or a time resource (T1). The WD 22 is further configured or scheduled to transmit a second uplink signals (S2) during a second time period or a time resource (T2) which occurs at least partly within T1, i.e., T2 at least partly overlap in time with T1. The part of T2 which overlaps with T1 is denoted herein as T0. Each time period or time resource T1, T2 and T3 has a respective duration. At least the overlapping part of T2 is such that: T0<T1. If T0=T2 (i.e., if T2 fully overlaps with T1) then T2<T1. For simplicity in providing details of this embodiment, it is assumed that T0=T1, i.e., T1 fully overlaps with T2 and T1<T2. This overlapping is illustrated in FIG. 16 where the maximum output power of the wireless device is re-estimated for transmission in T3 due to the occurrence of preemption in T2. However, one or more embodiments are also applicable for the case when T1 only partly overlaps with T2, i.e., T0<T1. Examples of T1 and T2 are slot and mini-slot respectively. Examples of S1 are one or more mobile broadband signals or enhanced mobile broadband signals (e.g., MBB, eMBB). Examples of S2 are one or more signals associated with high reliability and/or with low latency (e.g., Higher reliable low latency communications (HRLLC), URLLC, etc.). As an example, the terms high reliability or ultrareliable may refer to a target BLER of 10-5 or lower. As an example, the terms low latency or very short round trip time may refer to target round trip time of a packet not exceeding 1 ms. The WD 22 can be configured with both time resources T1 and T2 and can be scheduled with any of the signals, S1 or S2 any time. As an example, S2 is considered to be of higher priority with respect to S1. If the WD 22 is scheduled with S2, then the WD 22 is required to preempt the ongoing transmission of S1 and instead transmit S2.

The WD 22 can be configured or scheduled to transmit UL signals S1 and/S2 based on one or more of:

a message (e.g., uplink grant) received from the network node 16 (or any other node) for either aperiodic or periodic transmissions,

internal triggering in the WD 22 (e.g. autonomous transmission, random access, upon expiry of timer, etc.), etc.

The transmission of S2 during T2 is also called herein as a pre-emption or uplink preemption or puncturing of at least part of signal S1.

The WD 22 estimates a first transmit power level (P1) for transmitting S1 during T1. The WD 22 may then start transmitting S1 using the estimated power level P1. This may imply that the WD 22 may be required to transmit S1 in T1 with a power not exceeding P1. The WD 22, upon receiving a request to transmit S2 in T2, may further estimate a second transmit power level (P2) for transmitting signals S2 during T2. The WD 22 transmits S2 during T2 using the estimated power P2. This may also imply that the WD 22 is required to transmit S2 in T2 with a power not exceeding P2. The transmission of S1 during T2 is typically assumed to be suspended by the WD 22, e.g., WD 22 stops transmission of S1 in T2.

For transmitting S1 signals in a remaining part of T2, the WD 22 may further evaluate or estimate the transmit power of the WD 22. The remaining part of T2 is referred to herein as a third time period (T3) as shown in FIG. 16. The remaining part of S1 that is not transmitted during T2 due to preemption by S2 may also interchangeably be called as a third signal (S3).

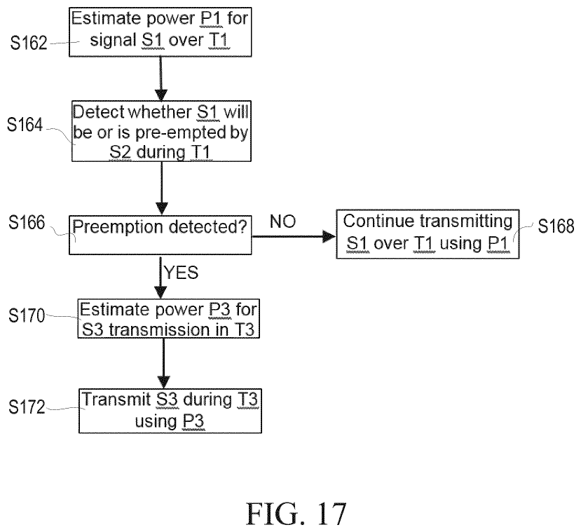

An example of the flow chart to illustrate the procedure for estimating P3 if the preemption of S1 occurs due to S2 is illustrated in FIG. 17. In one or more embodiments, wireless device 22 such as via one or more of processing circuitry 84, processor 86 and radio interface 82 is configured to estimate (block S162) power P1 for signal S1 over T1, as described herein. In one or more embodiments, wireless device 22 such as via one or more of processing circuitry 84, processor 86 and radio interface 82 is configured to detect (block S164) whether S1 will be or is pre-empted by S2 during T1, as described herein. In one or more embodiments, wireless device 22 such as via one or more of processing circuitry 84, processor 86 and radio interface 82 is configured to determine (block S166) whether preemption is detected, as described herein. In one or more embodiments, wireless device 22 such as via one or more of processing circuitry 84, processor 86 and radio interface 82 is configured to, if preemption is not detected, continue transmitting (block S168) S1 over T1 using P1, as described herein. In one or more embodiments, wireless device 22 such as via one or more of processing circuitry 84, processor 86 and radio interface 82 is configured to, if preemption is detected, estimate (block S170) power P3 for S3 transmission in T3, as described herein. In one or more embodiments, wireless device 22 such as via one or more of processing circuitry 84, processor 86 and radio interface 82 is configured to transmits (block S172) S3 during T3 using P3, as described herein.

The estimated transmit power during T3 is referred to herein as a third transmit power (T3), i.e., for transmitting S3 in T3. The WD 22 estimates or calculates or derives or determines the value of P3 based on a function which depends on at least the parameter P1 and P2.

The adjustment of power P3 in T3 due to the uplink preemption is such that certain criteria such as total output power of the WD 22 may be satisfied, e.g., average power across the entire T1 time period regardless of whether preemption occurs or not may remain constant. This helps ensure that the WD 22 emission requirements may be met and also that the interference may not exceed beyond certain limit. Implementation of the output power determinations may be implemented by the WD 22 by a rule which may be governed by a function as described below with several examples.

One example of a general function to estimate P3 is expressed by (1):

P3=f(P1, P2, μ) (1)

where μ is a scaling factor which accounts for the WD 22 implementation margin, e.g., imperfections in the radio transmitter of the WD 22. As a special case, μ=1 in log scale or μ=0 in linear scale.

An example of a specific function for deriving P3 is expressed in (2) assuming all parameters are in a linear scale:

P3=MAX (0, {P1-(P2-P1)}) (2)

An example of a specific function for deriving P3 is expressed in (3) assuming all parameters are in a linear scale:

P3=MAX (0, {P1-(P2-P1)-μ}) (3)

Another example of a general function to estimate P3 is expressed by (4):

P3=f(P1′, P1″, P2, μ) (4)

where:
P1′ is estimated by the WD 22 for transmitting S1 but over a duration T1′ and
P1″ is estimated by the WD 22 for transmitting S1 over a duration T1″.

Examples of T1′ and T1″ are expressed by (5) and (6) as follows:

T1′=T1-T2-T3 (5)

T1″=T2 (6)

In the above examples, the WD 22 estimates P r over a duration of the slot where the WD 22 has transmitted the S1 before the transmission of S2, i.e., before S1 is pre-empted by the transmission of S2. Also, the WD 22 estimate P1″ over a duration in which WD 22 has or may transmit S2. This approach, in expression (4), may lead to more accurate estimation of P3 during T3.

An example of a specific function for deriving P3 based on (4) is expressed in (7) assuming all parameters in linear scale. Another specific example is expressed in (8):

P3=MAX (0, {P1′-(P2-P1″)}) (7)

P3=MAX (0, {P1′-(P2-P1″)-μ}) (8)

The WD 22, upon determining the parameter P3, may transmit the signals, S3, (i.e., remaining part of S1 that was stopped or suspended due to preemption by S2 in T2) in T3 while helping to ensure that the WD 22 transmit power may not exceed P3. The WD 22 can however transmit with a power less than P3 in T3.

According to yet another aspect of this embodiment, the WD 22 can be configured to estimate P3 and/or transmit S1 in T3 based on one or more rules. The rules can be pre-defined and/or configured at the WD 22 by the network node 16. The rules may depend on one or more parameters related to estimation period of the transmit power, transmit power, etc. Examples of rules are:

Rule 1. The WD 22 may estimate P3 for S3 transmission (i.e., remaining part of S1) in T3 upon pre-emption of S2 signals in T2 depending on the parameters P1, P2, T1 and T2. For example, the WD 22 may estimate P3 for S3 transmission in T3 provided that one or more of the following operating conditions are met:
P2 is smaller than certain threshold (e.g. less than 20 dBm);
P2 is not larger than P1 by certain margin (e.g. P2 is not larger than 6 dB);
T2 is smaller than certain threshold (e.g. less than 5 symbols etc);
T2 is smaller than T1 by at least certain margin (e.g. T2 is smaller than 9 symbols with respect to T1, etc);
S2 occurs in certain part, i.e., location, of the time period, T1 e.g. in first half of the slot for S1 or up to 10th symbol of the slot where S1 can be transmitted, etc.

Rule 2. Even if the WD 22 has estimated P3, the WD 22 may transmit S3 in T3 using the estimated transmit power P3, depending on the values of parameters P1, P2, T1 and T2 or their mutual relation thereof. For example, the WD 22 may transmit S3 in T3 using the estimated power P3 provided that one or more operating conditions are met. Examples of the operating conditions are the same as described Rule 1.

Examples of methods in a WD 22 and a network node 16 implementing the above embodiments are described below.

An example of the method in a WD 22 capable of operating in both slot and mini-slot transmission, including the steps of:
Step-1: Determining a first transmit power parameter (P1) for transmitting a first signal (S1) over a first time period (T1),
Step-2: Determining whether the WD 22 is transmitting or is expected to transmit a second signal (S2) over a second time period (T2), where T2 occurs at least partly during T1 and where T2<T1,
Step-3: If it is determined that S2 is going to be transmitted or is being transmitted over T2 within T1 then determining a third transmit power parameter (P3) for transmitting a third signal (S3), which is the remaining part of the signals (S2) over a third time period (T3), where T3 is the remaining transmission duration of T1 for transmitting S3, which is the remaining part of the signal S3, and transmitting S3 over T3 using P3, and
Step-4: If no preemption occurs then transmitting S1 over entire T1 (including T3) using P1, otherwise transmitting S3 over T3 using P3.

An example of a method in a network node 16 including the steps of:
Step-1: Scheduling or configuring a WD 22 to transmit a first signal (S1) over a first time period (T1),
Step-2: Further scheduling or configuring the WD 22 to transmit a second signal (S2) over a second time period (T2), wherein T2<T1 and T2 occurs at least partly during T1,
Step-3: Receiving from the WD 22:
   Signals S1 from WD 22 using a first transmit power parameter (P1) in the entire T1 if the WD 22 does not transmit S2 in T2 or at least before the transmission of S2 if the UE transmits S2 in T2,
   Signals S2 during T2 using a second transmit power parameter (P2), and
   Signals S3 during T3 using a third transmit power parameter (P3) if the S2 is transmitted in T2, wherein T3=T1-2 and T3 occurs after T2.
Step-4: Using one or more received signals for performing one or more operational tasks e.g. demodulation of the received signals, channel estimation, power control of UL signals, measurements on the received signals, adaption of scheduling of signals, etc.

According to yet another example, a method in a network node 16 includes:
Step-1: Determining that a WD 22 is scheduled or configured to transmit a first signal (S1) over a first time period (T1),
Step-2: Determining whether or not the WD 22 is further scheduled or configured to transmit a second signal (S2) over a second time period (T2),
wherein T2<T1 and T2 occurs at least partly during T1,
   Step-3: Receiving from the WD 22:
   Signals S1 using a first transmit power parameter (P1) in the entire T1 if it is determined that the WD 22 may not be scheduled to transmit S2 in T2, or
   If it is determined that the WD 22 is scheduled or configured to transmit S2 in T2, the receiving includes receiving:
      signals S1 using P1 in part of T1 until the occurrence of T2,
      signals S2 during T2 using a second transmit power parameter (P2) and signals S3 during T3 using a third transmit power parameter (P3), wherein T3=T1-2 and T3 occurs after T2.
   Step-4: Using one or more received signals for performing one or more operational tasks, e.g., demodulation of the received signals, channel estimation, power control of UL signals, measurements on the received signals, adaption of scheduling of signals etc.

Some Examples:

Example A1. A network node 16 configured to communicate with a wireless device 22 (WD 22), the network node 16 configured to, and/or comprising a radio interface 62 and/or comprising processing circuitry 68 configured to:

configure a wireless device 22 to transmit one or more first signals over a first time period;

configure the wireless device 22 to transmit one or more second signals over a second time period where the second time period is less than the first time period and the second time period at least partially overlaps the first time period;

receive at least a portion of the one or more first signals, transmitted using a first transmit power parameter, during the first time period;

if the one or more second signals, transmitted using a second transmit power parameter, are received during the second time period, receive a remaining portion of the one or more first signals, transmitted using a third transmit power parameter, during a third time period where the third time period occurs after the second time period; and

perform at least one operational task based on the received one or more first signals and one or more second signals.

Example A2. The network node 16 of Example A1, wherein transmission of the one or more first signals during a portion of the first time period are preempted by the transmission of the one or more second signals during the second time period.

Example A3. The network node 16 of Example A1, wherein the third transmit power parameter is based on the first transmit power parameter, second transmit power parameter, first time period and second time period.

Example B1. A method implemented in a network node 16, the method comprising:

configuring a wireless device 22 to transmit one or more first signals over a first time period;

configuring the wireless device 22 to transmit one or more second signals over a second time period where the second time period is less than the first time period and the second time period at least partially overlaps the first time period;

receiving at least a portion of the one or more first signals, transmitted using a first transmit power parameter, during the first time period;

if the one or more second signals, transmitted using a second transmit power parameter, are received during the second time period, receiving a remaining portion of the one or more first signals, transmitted using a third transmit power parameter, during a third time period where the third time period occurs after the second time period; and

performing at least one operational task based on the received one or more first signals and one or more second signals.

Example B2. The method of Example B1, wherein transmission of the one or more first signals during a portion of the first time period are preempted by the transmission of the one or more second signals during the second time period.

Example B3. The method of Example B1, wherein the third transmit power parameter is based on the first transmit power parameter, second transmit power parameter, first time period and second time period.

Example C1. A wireless device 22 (WD 22) configured to communicate with a network node 16, the WD 22 configured to, and/or comprising a radio interface 82 and/or processing circuitry 84 configured to:

determine a first transmit power parameter for transmitting one or more first signals during a first time period;

if one or more second signals are to be transmitted or are expected to be transmitted using a second transmit power parameter during a second time period, determine a third transmit power parameter for transmitting a portion of the one or more signals during a third time period, the second time period being less than the first time period where the second time period at least partially overlaps the first time period, the third time period occurring after the second time period; and

transmit the one or more first signals and/or one or more second signals.

Example C2. The WD 22 of Example C1, wherein transmission of the one or more first signals during a portion of the first time period are preempted by the transmission of the one or more second signals during the second time period.

Example C3. The WD 22 of Example C1, wherein the third transmit power parameter is based on the first transmit power parameter, second transmit power parameter, first time period and second time period.

Example D1. A method implemented in a wireless device 22 (WD 22), the method comprising:

determining a first transmit power parameter for transmitting one or more first signals during a first time period;

if one or more second signals are to be transmitted or are expected to be transmitted using a second transmit power parameter during a second time period, determining a third transmit power parameter for transmitting a portion of the one or more signals during a third time period, the second time period being less than the first time period where the second time period at least partially overlaps the first time period, the third time period occurring after the second time period;

transmitting the one or more first signals and/or one or more second signals.

Example D2. The method of Example D1, wherein transmission of the one or more first signals during a portion of the first time period are preempted by the transmission of the one or more second signals during the second time period.

Example D3. The method of Example D1, wherein the third transmit power parameter is based on the first transmit power parameter, second transmit power parameter, first time period and second time period.

Example E1. A network node 16, comprising:

a configuration module 33 configured to:
configure a wireless device 22 to transmit one or more first signals over a first time period;
configure the wireless device 22 to transmit one or more second signals over a second time period where the second time period is less than the first time period and the second time period at least partially overlaps the first time period;

a receiving module 77 configured to:
receive at least a portion of the one or more first signals, transmitted using a first transmit power parameter, during the first time period;
if the one or more second signals, transmitted using a second transmit power parameter, are received during the second time period, receive a remaining portion of the one or more first signals, transmitted using a third transmit power parameter, during a third time period where the third time period occurs after the second time period; and

an operational module 79 configured to perform at least one operational task based on the received one or more first signals and one or more second signals.

Example E2. A wireless device 22, comprising:

a determination module 35 configured to:
determine a first transmit power parameter for transmitting one or more first signals during a first time period;
if one or more second signals are to be transmitted or are expected to be transmitted using a second transmit power parameter during a second time period, determine a third transmit power parameter for transmitting a portion of the one or more signals during a third time period, the second time period being less than the first time period where the second time period at least partially overlaps the first time period, the third time period occurring after the second time period; and

transmitting module 95 configured to transmit the one or more first signals and/or one or more second signals.

Example E3. A host computer 24, comprising:

a communication module 55 configured to communicate information associated with a transmission of one or more first signals and one or more second signals, the one or more second signals preempting the transmission of a portion of the one or more first signals during a time period.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, the network node comprising processing circuitry and a radio interface, the processing circuitry configured to:
receive, via the radio interface during a first time period, a portion of a first scheduled transmission having a first transmission power based at least in part on a first transmit power parameter;
receive, via the radio interface during a second time period that at least partially overlaps the first time period, a second scheduled transmission having a second transmission power based at least in part on a second transmit power parameter different from the first transmit power parameter; and
receive, via the radio interface during a third time period occurring after the second time period, a remaining portion of the first scheduled transmission having a third transmission power based at least in part on a third transmit power parameter different from the second transmit power parameter, the third transmit power parameter being based at least in part on at least one operating condition of the second scheduled transmission.

2. The network node of claim 1, wherein the second scheduled transmission preempts transmission of the first scheduled transmission during the second time period.

3. The network node of claim 1, wherein the at least one operating condition of the second scheduled transmission includes at least one of:
a duration of the second time period;
the second transmission power; and
a location of the second scheduled transmission within a slot.

4. The network node of claim 1, wherein the third transmit power parameter is based at least in part on at least one of:
a duration of the first time period; and
the first transmission power.

5. The network node of claim 1, wherein the third transmit power is based at least in part on a rule which includes whether the second transmit power parameter is below a predefined threshold or whether a duration of the second time period is below a predefined duration threshold.

6. The network node of claim 1, wherein the third transmit power is based at least in part on a rule which includes whether the second transmit power parameter is larger than the first transmit power parameter and within a predefined margin of the first transmit power parameter.

7. (canceled)

8. The network node of claim 1, wherein the third transmit power is based at least in part on a rule which includes whether a duration of the second time period is less than a duration of the first time period and within a predefined margin of the duration of the first time period.

9. The network node of claim 1, wherein the third transmit power is based at least in part on a rule which includes whether the second scheduled transmission occurs within a predefined portion of a slot.

10. The network node of claim 1, wherein the first transmission power, second transmission power and third transmission power meet a predefined total output power criteria.

11. A wireless device configured to communicate with a network node, the wireless device comprising processing circuitry and a radio interface, the processing circuitry configured to:
cause the radio interface to transmit, during a first time period, a portion of a first scheduled transmission having a first transmission power based at least in part on a first transmit power parameter;
cause the radio interface to transmit, during a second time period that at least partially overlaps the first time period, a second scheduled transmission having a second transmission power based at least in part on a second transmit power parameter different from the first transmit power parameter; and
cause the radio interface to transmit, during a third time period occurring after the second time period, a remaining portion of the first scheduled transmission having a third transmission power based at least in part on a third transmit power parameter different from the second transmit power parameter, the third transmit power parameter being based at least in part on at least one operating condition of the second scheduled transmission.

12. The wireless device claim 11, wherein the second scheduled transmission preempts transmission of the first scheduled transmission during the second time period.

13. The wireless device of claim 11, wherein the at least one operating condition of the second scheduled transmission includes at least one of:
a duration of the second time period;
the second transmission power; and
a location of the second scheduled transmission within a slot.

14. The wireless device of claim 11, wherein the third transmit power parameter is based at least in part on at least one of:
a duration of the first time period; and
the first transmission power.

15. The wireless device of claim 11, wherein the third transmit power is based at least in part on a rule which includes whether the second transmit power parameter is below a predefined threshold or whether a duration of the second time period is below a predefined duration threshold.

16. The wireless device of claim 11, wherein the third transmit power is based at least in part on a rule which includes whether the second transmit power parameter is larger than the first transmit power parameter and within a predefined margin of the first transmit power parameter.

17. (canceled)

18. The wireless device of claim 11, wherein the third transmit power is based at least in part on a rule which includes whether a duration of the second time period is less than a duration of the first time period and within a predefined margin of the duration of the first time period.

19. The wireless device of claim 11, wherein the third transmit power is based at least in part on a rule which includes whether the second scheduled transmission occurs within a predefined portion of a slot.

20. The wireless device of claim 11, wherein the first transmission power, second transmission power and third transmission power meet a predefined total output power criteria.

21. A method performed by network node configured to communicate with a wireless device, the method comprising:
receiving, during a first time period, a portion of a first scheduled transmission having a first transmission power based at least in part on a first transmit power parameter;
receiving, during a second time period that at least partially overlaps the first time period, a second scheduled transmission having a second transmission power based at least in part on a second transmit power parameter different from the first transmit power parameter; and
receiving, during a third time period occurring after the second time period, a remaining portion of the first scheduled transmission having a third transmission power based at least in part on a third transmit power parameter different from the second transmit power parameter, the third transmit power parameter being based at least in part on at least one operating condition of the second scheduled transmission.

22-30. (canceled)

31. A method for a wireless device configured to communicate with a network node, the method comprising:
transmitting, during a first time period, a portion of a first scheduled transmission having a first transmission power based at least in part on a first transmit power parameter;
transmitting, during a second time period that at least partially overlaps the first time period, a second scheduled transmission having a second transmission power based at least in part on a second transmit power parameter different from the first transmit power parameter; and
transmitting, during a third time period occurring after the second time period, a remaining portion of the first scheduled transmission having a third transmission power based at least in part on a third transmit power parameter different from the second transmit power parameter, the third transmit power parameter being based at least in part on at least one operating condition of the second scheduled transmission.

32-40. (canceled)
